(19) United States
(12) Patent Application Publication
(10) Pub. No.: US 2015/0113429 A1
(43) Pub. Date: Apr. 23, 2015

(54) Real-time dynamic content display layer and system

(71) Applicant: NQ Mobile Inc., Dallas, TX (US)

(72) Inventors: Christopher Conrad Edwards, Richardson, TX (US); Gerardo A. Gean, Lewisville, TX (US); Renjith Ramachandran, Plano, TX (US)

(73) Assignee: NQ Mobile Inc., Dallas, TX (US)

(21) Appl. No.: 14/520,298

(22) Filed: Oct. 21, 2014

Related U.S. Application Data
(60) Provisional application No. 61/893,824, filed on Oct. 21, 2013.

(51) Int. Cl. G06F 3/0484; H04L 29/08

(52) U.S. Cl. CPC G06F 3/0484; H04L 67/10
USPC 715/746

(57) ABSTRACT

A mobile device user interface typically presents a static home screen that allows a user to initiate applications so that they may view and consume content. The present disclosure provides systems and methods for providing content as well as contextual functionality more fluidly on mobile devices. A live wallpaper may be instantiated on mobile devices such that a background layer presented as part of a home screen is closely coupled to associated applications. Both the background layer and the associated applications may provide content and contextual functionality based on data and metadata received from servers external to the mobile devices, leading to a highly dynamic and engaging experience.

### RELATED APPLICATIONS

The present application relates and claims priority to U.S. Provisional Patent Application No. 61/893,824, entitled “Real-time dynamic content display layer and system,” filed Oct. 21, 2013, which is hereby incorporated by reference in its entirety.

### BACKGROUND

1. Technical Field

Enclosed is a detailed description of systems and methods for dynamic delivery and presentation of content and functionality to mobile device users.

2. Related Art

Mobile device user interfaces typically involve a distinct foreground and background. The foreground generally comprises application icons and widgets. The background serves the complementary purpose of displaying customizable, but largely static, visual content. Accordingly, the background has traditionally been a cosmetic component, and UIs have been designed to draw a user's focus to the foreground content.

User interactions with mobile devices may be separated into two types: deterministic interactions and opportunistic interactions. Deterministic interactions occur when the user utilizes a mobile device in a purposeful manner to perform actions that are largely pre-determined by the user. Such interactions may include, for example, sending emails and making phone calls. In contrast, opportunistic interactions occur when the user does not have a specific intent when interacting with the mobile device. In some scenarios, the user may utilize the mobile device to simply “pass the time” when unoccupied with other activities. Given the prevalence of mobile devices in the market and culture, these opportunistic interactions are becoming increasingly common and present an opportunity for improving user experience.

### SUMMARY

One aspect of the present disclosure is enhancing the user experience during opportunistic interactions, while also adding value for brands, ad networks, and partner services, among other parties. In some embodiments, the previously under-utilized background layer (e.g., wallpaper) of a mobile device user interface may present interactive and dynamic content to the user. The result is a real-time, dynamic content-driven system, providing an immersive, live, UI experience that is exciting, engaging, and actionable.

The systems and methods of the present disclosure blend the functionality of the foreground and background to provide a cohesive interface to users. A well-defined set of modes, states, and transitions may be implemented to achieve this goal. In the context of this disclosure, modes are set through user interaction, whereas states are platform- or technology-driven. In some embodiments, the disclosed systems may include two modes: a background layer mode and a full-screen application mode. Transitions may seamlessly bridge the background layer mode with the full-screen application mode where user-selected content may be brought to the foreground.

Another aspect of the present disclosure involves a unique complement to traditional stand-alone applications for presenting content. The present disclosure provides a framework that may directly pull both content and functionality from servers of content providers on an as-needed basis. The framework allows content providers to increase visibility of their content and to promote their stand-alone applications through engaging techniques and presentations. The framework also allows for content to vary based on contexts such as time, location, user behavior, historical information, and/or other contexts without necessitating full application updates.

Another aspect of the present disclosure involves an architecture that efficiently exploits the capabilities of hardware within mobile devices, while taking into account limitations of said hardware. The architecture may keep a mobile device in a passive state whenever possible. In this passive state, the power consumption and processor utilization of the mobile device may be minimal. In order to further minimize power consumption, the platform may reside in an active or event-driven state for brief durations to process user input or other events.

A further aspect of the present disclosure involves a robust development environment that provides multiple integration paths for integration of partner services. The integration may occur through the use of software development kits (SDK's) and application programming interfaces (API's) for integration with partners. In other situations, developers may extend the platform by integrating other partner services though API's.

In some embodiments, the experience presented by the live display system is highly customizable, allowing users to select specific themes to reflect their affinity towards various brands or to gain easier access to preferred content such as streaming video. In other embodiments, the system is able to provide specific themes based on a user's previous interactions with the system. Mobile device services such as media players, utilities, applications, settings, or other services may also be enhanced and integrated into a live display client-side layer defined by the architecture.

In general, where functionality is provided, the functionality may be driven by the content and defined by the context, where context may refer to the time, location, user behavior, historical information, and/or other contexts. Much of this functionality can be extracted from traditional applications and smoothly integrated into the live display client-side layer.

### BRIEF DESCRIPTION OF THE DRAWINGS

Features, aspects, and embodiments of the disclosure are described in conjunction with the attached drawings, in which:

FIGS. 1A-1B are block diagrams illustrating high-level system architectures underlying some embodiments of the presently disclosed live display system;

FIG. 2 is a schematic diagram of a multi-mode architecture of a live display system;

FIG. 3 is schematic diagram of a multi-state architecture that may be used to implement the multi-mode architecture of FIG. 2;

FIG. 4 is a block diagram of a brand engagement ecosystem illustrating some elements of a mobile device with which the live display system may interact;

FIG. 5 is a schematic diagram illustrating three implementations of integrated ad displays;

FIG. 6 is a block diagram of a development ecosystem 600 associated with the live display system in some embodiments;

FIG. 7 shows a schematic diagram illustrating the mobile device's home screen when in a background layer mode;

FIG. 8 shows a schematic diagram illustrating how the mobile device may enter a full-screen application mode;

FIG. 9 shows a schematic diagram illustrating another example of dynamic application content and functionality; and

FIGS. 10A-10B show schematic diagrams illustrating a sample home screen of a mobile device having a tray.

These exemplary figures and embodiments are to provide a written, detailed description of the subject matter set forth by any claims that issue from the present application. These exemplary figures and embodiments should not be used to limit the scope of any such claims.

Further, although similar reference numbers may be used to refer to similar structures for convenience, each of the various example embodiments may be considered to be distinct variations.

### DETAILED DESCRIPTION

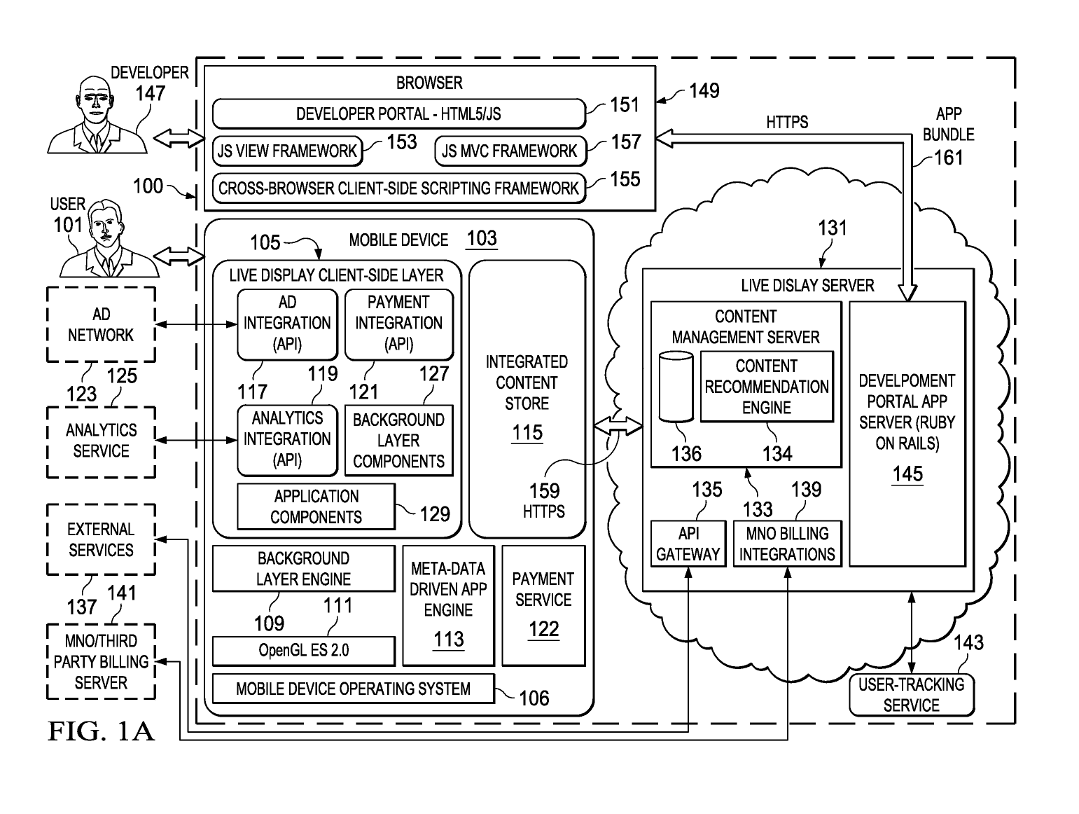

FIG. 1A is a block diagram illustrating a high-level system architecture underlying some embodiments of the presently disclosed live display system 100.

According to described embodiments of the present disclosure, a user 101 interacts with his or her mobile device 103 via the mobile device's user interface (UI). The UI is presented, at least in part, by a live display client-side layer 105. The mobile device 103 may comprise a plurality of components that may be modified to create an environment upon which the live display client-side layer 105 is built. In some embodiments, the mobile device operating system (OS) 106 may be Android. In other embodiments, other mobile operating systems (e.g., iOS, Windows, BlackBerry) may be used. The mobile device 103 may be running a background layer engine 109 for providing a background layer as will be described further below and an accelerated graphics engine 111 (such as OpenGL ES 2.0). These engines may be optimized to provide for minimal power consumption, application sizes, and memory usage. The mobile device 103 may also run a metadata-driven application engine 113, which provides a dynamic experience when the mobile device 103 is in a full-screen application mode. As will be described further in FIG. 1B, the metadata-driven application engine 113 may provide for both content and embedded functionality (e.g., a music player with buttons) to be pushed to the mobile device 103.

The described engines and components enable the mobile device 103 to provide the live display client-side layer 105 and one or more integrated content stores 115 to the user 101. The integrated content stores 115 refer to branded or unbranded electronic marketplaces that may be created by various parties to sell and market digital content. Though FIG. 1A presents the integrated content stores 115 as separate from the live display client-side layer 105, the integrated content stores 115 may be built as applications using the streamlined architecture provided by the live display client-side layer 105. The integrated content stores may be pre-loaded into the mobile devices 103 or may be added by the user 101 or a service provider at a later time.

The live display client-side layer 105 may comprise ad integration 117, analytics integration 119, and payment integration 121. The ad integration 117 may be implemented by developing the live display client-side layer 105 using an application programming interface (API) provided by an ad network 123 to connect the live display client-side layer 105 to the ad network 123. Similarly, the analytics integration 119 may be implemented by developing the live display client-side layer 105 using an API provided by an analytics service 125 to connect the live display client-side layer 105 to the analytics service 125. Both Google and Flurry provide APIs to incorporate their respective analytics services into mobile device systems. The payment integration 121 may connect the live display client-side layer 105 to a payment service 122. In some embodiments, the payment service 122 may be the Google Play service or another service that may run locally on the mobile device 103.

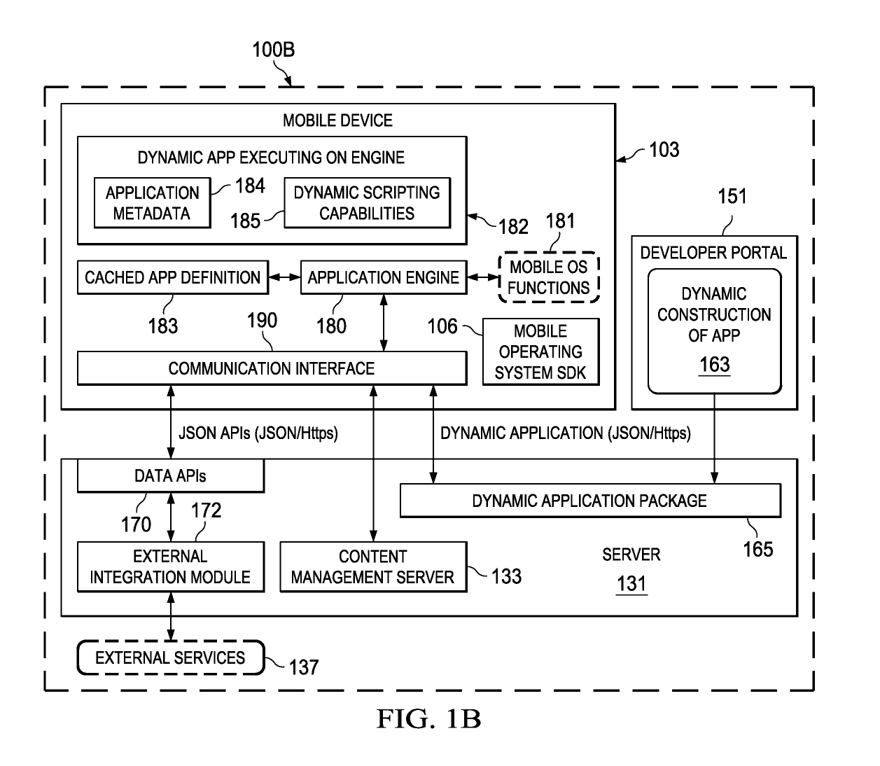

The live display client-side layer 105 may comprise background layer components 127 that can be presented to the user when the live display layer 105 is running in a background layer mode and application components 129 that may be presented to the user 101 when the live display layer 105 is running in a full-screen application mode. The application components 129 may be implemented using native interface rendering techniques provided by the mobile device operating system 106 and/or other rendering techniques such as HTML5. The background layer mode and the full-screen application mode are described in more detail in the description of FIG. 2, below.

Referring back to FIG. 1A, the mobile device 103 may be in communication with a live display server 131, which may be implemented with a cloud-based solution. The live display server 131 may comprise a content management server 133 that provides a streamlined means for storing and delivering content and applications to the live display layers 105 of mobile devices 103 in the live display system 100. The content management server 133 may include a content recommendation engine 134 that would allow for personalized content to be sent to individual mobile devices 103 based on information collected on or provided by the user 101.

The live display server 131 may also provide an API gateway 135 for allowing external services 137 to interact directly with the live display server 131. For example, the external services 137 may request information from the live display server 131 about usage statistics. Additionally or alternatively, the external services 137 may provide content and contextual functionality to the live display server 131 to be presented at the mobile devices 103, as will be further discussed in FIG. 1B.

In some embodiments, the server 131 may have the capability of sending information to mobile network operator (MNO) billing servers 141 using a method of MNO billing integration 139. This would provide the benefit of allowing a user 101 to pay for content and/or applications through the standard recurring bill associated with his or her mobile device 103, such as a monthly phone bill. The user 101 may then bypass entering personal information such as credit card numbers into third party systems when so desired.

The server 131 may further be capable of communicating with a user-tracking service 143 that may be operated by the same entity as that which operates the server 131. The user-tracking service 143 may collect and store information on individual and identifiable users 101, preferably when individual users 101 grant permission to do so. The user-tracking service 143 may also collect aggregate data on many users 101 of the live display system 100. This data may be analyzed to detect trends, measure the efficiency of marketing strategies, or for numerous other purposes. The aggregate data may also be used to iteratively improve the user experience.

The structure of the live display server 131 may also provide for a development portal application server 145. In some embodiments, the development portal application server 145 may be implemented using the Ruby on Rails web application framework. Other web application frameworks may also be used.

In some embodiments, one or more developers 147 may be able to access a development portal 151 via a mobile or desktop web browser 149. The development portal 151 may provide the developer 147 access to tools for developing applications for the live display system 100. These tools may include HTML5 and JavaScript (JS). The developer 147 may also be presented with an application bundle to assist them with development of their own applications that may be intended to function on mobile devices 103 with a live display client-side layer 105. The developer 147 may also access other tools in their web browser such as a layout framework 153, a client-side scripting library 155, and a model-view-controller (MVC) framework 157. The layout framework 153 may assist with front-end development when integrating partner services. One example of a layout framework 153 is the Bootstrap framework. JQuery is a popular choice for the client-side scripting library 155. Similarly, backbone.js may be used for the MVC framework 157. In some embodiments, a plurality of layout frameworks 153, client-side scripting libraries 155 and/or MVC frameworks 157 may exist. The developer 147 may use numerous other development tools in place of, or in addition to, the aforementioned technologies.

The plurality of mobile devices 103 may be connected to the live display server 131 using a first Hypertext Transfer Protocol Secure (HTTPS) connection 159. The first HTTPS connection 159 may allow the live display server 131 to send content to the plurality of mobile devices 103. An individual mobile device 103 may send information to the live display server 131 using the first HTTPS connection 159. The one or more web browsers 149 of the one or more developers 147 may be connected to the development portal application server 145 via a second HTTPS connection 161.

The technologies referenced in this application serve as examples, and a person of ordinary skill in the art may utilize different technologies, yet the end system may still fall within the scope of this application. For example, the mobile devices 103 may be running a version of Apple's iOS or Research In Motion's BlackBerry OS instead of the Linux-based Android OS. As another example, alternative uniform resource identifier (URI) schemes such as HTTP may be used to implement the connection 159, the connection 161, or both of the connections 159 and 161. HTTPS is chosen in some embodiments as it provides an added level of security; however, those skilled in the art would be able to change the architecture to use alternative or additional technologies. Furthermore, modifications may be made to adapt the system to utilize new technologies as they arise.

In general, connections 159 and 161 may be implemented using methods other than traditional web protocols. In some embodiments, the client-server relationship may be fully or partially replaced with a peer-to-peer relationship. In these embodiments, direct connections between mobile devices 103 may serve as connection 159. In certain cases, data may be aggregated locally on individual mobile devices 103. This arrangement would provide some of the benefits of the live display system 100 without necessitating network connectivity.

In some embodiments, the live display client-side layer 105 may be pre-installed on mobile devices 103. However, if the live display client-side layer 105 is not already installed on an individual mobile device 103, the associated user 101 may install the live-display client-side layer 105 on the mobile device 103, so that the user 101 may experience the benefits of the live display system 100. An individual user 101 may be presented with the installation option via at least one integrated content store 115 that is accessible from the user's mobile device 103.

The users 101 may be presented with a variety of options when selecting themes for the live display client-side layers 105 on their mobile devices 103. These themes, which may influence the background layer components 127 as well as the application components 129, may also be referred to as a “live wallpapers.” For example, a sports fan may be able to select a live wallpaper associated with a professional sports league such as the National Basketball Association (NBA). The live wallpaper may alternatively (or additionally) be tied to a home integration service, a personal fitness service, a mobile network operator, and/or a content delivery service (e.g., for music, movies, and/or television). These live wallpapers are used only as examples, and a vast range of possibilities exists. The live wallpapers may provide both content as well as contextualized functionality to the mobile devices 103 in a dynamic manner. For example, a personal fitness service may integrate control functionality for a connected personal fitness device into a background layer component 127 or application component 129 that is pushed to the mobile devices 103.

The users 101 may access different live wallpapers through a variety of methods. For example, the live wallpapers may be presented within the integrated content stores 115. The users 101 may download and install live wallpapers from the stores 115 onto individual mobile devices 105.

Brands, service providers, content providers, and other entities having live wallpapers may advertise their live wallpapers to the users 101 through a multitude of advertising channels. One such channel may be traditional broadcast advertising with audio watermarks. The audio watermarks may be recognized by the mobile devices 103, prompting the mobile devices 103 to present live wallpapers to the users 101. Another advertising channel may be QR codes embedded within posters, billboards and other images. Other channels may include NFC integrated into physical objects and messages delivered via local WiFi, MMS and/or SMS. Many other advertising channels may be suitable.

Users 101 may be able to customize live wallpapers to match their preferences and desired experiences. In some embodiments, the users 101 may be able to set customizable animations and effects, customizable RSS feeds, customizable displays of local content (e.g., images, calendar, music, etc.) and/or other customizable features.

Users 101 may be able to share live wallpapers, both standard and customized, through various transport mechanisms. The transport mechanisms may include text messages (e.g., SMS, MMS), NFC, WiFi, Blutooth, and social networking services (e.g., Facebook, Twitter). Many other transport mechanisms may be suitable for the sharing of live wallpapers.

FIG. 1B is a block diagram of a system architecture of a live display system 100B that further describes exemplary sources of content and contextual functionality. Some elements of FIG. 1B are similar to those of FIG. 1A and the description of those elements will not be repeated here. Further, FIG. 1B highlights certain elements of the present disclosure, and other elements have not been shown for brevity. It is to be understood that any of the elements and principles described with respect to FIG. 1A may apply to the live display system 100B of FIG. 1B and vice versa.

As shown in FIG. 1B, the live display system 100B may comprise a developer portal 151 that provides for the dynamic construction 163 of an application. The developer portal 151 may comprise a graphical environment allowing a developer to select content and functionality from a library and drop the selected content and functionality within a mock presentation simulating the eventual presentation on mobile devices 103. The mock presentation may correspond to a particular type of mobile device (e.g., having a known resolution), and the presentation may be automatically and/or manually adapted for other mobile device types.

The library may comprise buttons, text fields, grids, tables, and frames for dynamic and static content. An example of static content would be a logo that may be shown within the header of a deployed application. Other examples of static content include video content, animated content, and audio content. Conversely, dynamic content may be determined after the application is deployed on the mobile device 103 and may vary based on time, location, user behavior, historical information, and/or other contexts. The developer portal 151 may allow dynamic frames such as a vertical or horizontal image-based news feed to be included within the deployed application. A music playlist could also be implemented as dynamic content, so that users may receive promoted and/or contextually-relevant music upon opening the deployed application.

The developer portal 151 may be in communication with a live display server 131. Following the construction 163 at the developer portal 151, the server 131 may receive, store, generate, and/or otherwise obtain a dynamic application package 165 corresponding to the constructed application. The dynamic application package 165 may include static content and functionality selected by the developer, as well as instructions for receiving dynamic (e.g., variable) content and contextual functionality on the mobile device 103.

The live display server 131 may provide the package 165 to the mobile device 103 via a communication interface 190, so that the mobile device 103 may instantiate a dynamic application 182 that is executed using the application engine 180 of the mobile device 103. The live display server 131 may further act as a direct or indirect provider of content or metadata for the dynamic application 183. The live display server 131 may provide a data API 170 that provides access to external services 137 (e.g., third party servers providing content feeds). Content and functionality from the external services 137 may be “mapped” into frames on the dynamic application 182 via the external integration module 172 on the live display server 131. For example, content from the external service 137 may be sent with metadata having instructions for formatting the content and/or providing contextual functionality associated with the content within the application 182. The metadata may also comprise references (e.g., URLs) pointing to locations from which content may be fetched at a later time. In some embodiments, the external integration module 172 may parse publically or privately broadcasted data feeds from external services 137 such that the feeds are renderable as part of the dynamic application 182 on the mobile device 103. This allows the live display system 100B to receive external content that is not specially formatted for use in the live display system 100B, thereby increasing the range of available content. The mobile device may 103 receive the content and associated metadata from the external services 137 and the content management server 133 via the communication interface 190, which may send the content and metadata to the application engine 180.

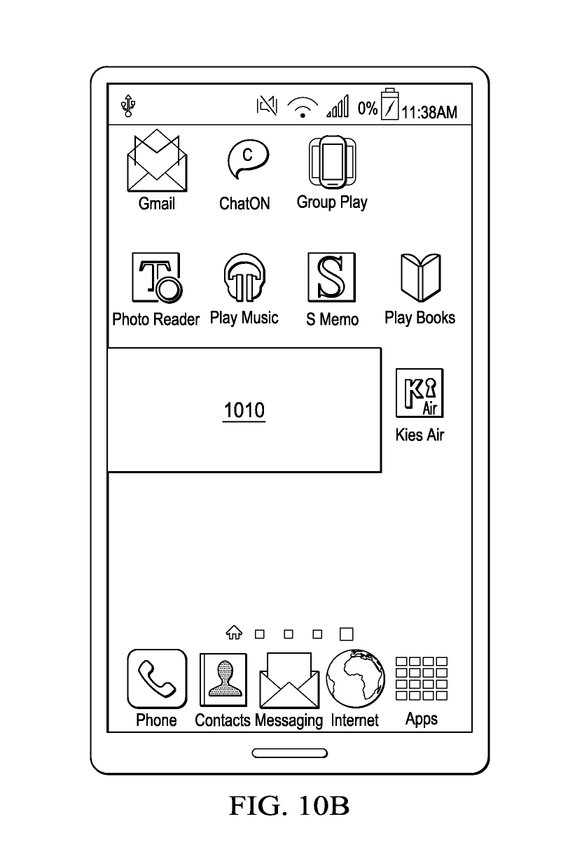

The dynamic application 182 may be manifested as a full screen application, a background layer, a tray as described in FIGS. 10A-10B, or any combination thereof. The application 182 may be considered dynamic in that the live display system 100B may provide flexibility to vary the content and even the functionality of the application 182 at the mobile device 103 without requiring the user to manually update the application 182 or even be aware of the update process. For example, dynamic application packages 165 can be transparently pushed to the mobile device 103 as desired by the content providers and/or owners of each live wallpaper. Upon pushing a new package 165, the layout and even functionality of the dynamic application 182 may be changed. The packages 165 may replace the application 182, in whole or in part, on the mobile device 103.

In some embodiments, the content and contextual functionality within the dynamic applications 182 may be changed without requiring a new package 165 to be sent to the mobile device 103. Here, contextual functionality may refer to interacting with content, through actions such as viewing, controlling, or even purchasing content. As described above, the dynamic applications 182 may include frames or placeholders to receive updated content and contextual functionality from the live display server 131. By providing new content and contextual functionality received from the external services 137 and/or the content management server 133, the dynamic application 182 may provide up-to-date and relevant content and contextual functionality that promotes increased user engagement without requiring new packages to be sent to the mobile device 103. For example, content and functionality within the dynamic application 182 may be coordinated with real-time events (e.g., sporting events, album releases, or movie premieres) or updated on a periodic or semi-periodic basis to promote user interest.

The dynamic application package 165 and the content and functionality received by the mobile device 103 may be cached, in whole or in part, in a local application cache 183 accessible by the application engine 180. The local application cache 183 may provide quick access to cached content and functionality, thereby improving the perceived performance of the dynamic applications 182. For example, the local application cache 183 may proactively cache content to be used in the dynamic applications 182, which may reduce load times. The local application cache 183 may also reduce unnecessarily repetitive downloads of content. For example, the local application cache 183 may store downloaded external content such that the mobile device 103 may limit download requests to times when updated or new external content is available from the live display server 131. The local application cache 183 may further store commonly used control (e.g., customized or generic buttons) or other interface elements (e.g., logos) that are likely to be reused.

The live display server 131 may send both content and functionality to the mobile device 103 as formatted data (e.g., using JavaScript Object Notation (JSON)) over a connection (e.g., HTTPS). In some embodiments, HTML5 may be used to provide the received content and functionality on the mobile device 103. When the initial source of data is one of the external services 137, the external integration module 172 may parse and reformat the data into a standard format convenient for rendering by the dynamic application engine 180. This may advantageously reduce computation on the mobile device 103 and further improve performance.

As discussed above, the application engine 180 may be developed on top of a mobile operating system software development kit (SDK) 106, such as Google's Android SDK. Accordingly, the application engine 180 may use operating system functions 181 to provide seamless integration and a familiar look-and-feel to users. For example, the SDK 106 may provide gesture functions 181 such as swiping and pointing. The SDK 106 may also provide graphical functions 181 for presenting content. The dynamic application 182 may include dynamic scripting capabilities 185 that provide variable functionality based on received data. For example, functionality may be added to the dynamic application 182 in a modular and extensible manner, such that the application 182 need not be recompiled to provide the new functionality. The dynamic scripting capabilities 185 may be implemented by a scripting runtime environment that is operable to provide integration points for one or more scripting languages (e.g., Lua, JavaScript, and/or similar languages) into the dynamic application 182. For example, the dynamic scripting capabilities 185 may be implemented by an interpreter or virtual machine capable of dynamically executing the scripting language. The dynamic application 182 may also include application metadata 184 (e.g., JSON data 184) that determines a structured presentation for the application's content and functionality. In addition, the application metadata may provide references (e.g., URLs) to locations from which dynamic content may be received. The application metadata 184 may be initially provided by the dynamic application package 165 and updated as a result of transmission s from the content management server 133 and/or the external services 137.

FIG. 2 is a schematic diagram of a multi-mode architecture 200 of a live display system.

The background layer mode 201 allows a user to interact with content displayed in the background, while preserving the visibility and interactivity of the foreground content. The background content provides for a visual experience that may include animations and a variable degree of interactivity. The background layer mode 201 may subtly draw user attention to background content and promote “discoverability” of this content while still allowing this content to remain “behind the scenes.” Foreground content may be overlaid on top of the background content.

The background layer mode 201 may be implemented using an accelerated graphics engine. A game engine and a physics engine may supplement the accelerated graphics engine to provide a maximal level of interactivity to the user.

The live display client-side layer provides for a seamless inter-mode transition 205 between the background layer mode 201 and a full-screen application mode 203. In some embodiments, the user may tap on an element of the background within the background layer mode 201 to transition to the full-screen application mode 203. Other gestures, such as a twist, peel, or shake of the device may also cause the inter-mode transition 205 to occur. The transition 205 may also be prompted by sound recognition and image/video recognition using the microphone and camera, respectively, of the mobile device. For example, the user may make a verbal request to the device, such that the device enters into full-screen application mode 203 displaying content requested by the user. Other sensors of the mobile device may also be used to prompt inter-mode transition 205. Some content may include time-based watermarks that may trigger inter-mode transition 205. For example, the transition 205 may occur after a pre-determined scene in a video.

When the transition 205 occurs, metadata may be stored and transferred such that the full screen application mode 203 would instantiate with knowledge of the prior context. The full-screen application mode 203 would involve focused, full-screen interaction between the user and the mobile device. The user experience in this mode would be immersive, actionable, and familiar for users who have used mobile applications in the past. In some embodiments, the user may be able to use the hardware navigation buttons that are present on many mobile devices to navigate the content presented in full-screen application mode 203. For example, a mobile device's standard hardware or software “back” button may allow the mobile device to undergo an inter-mode transition 205 back to the background layer mode 201 from the full-screen application mode 203. In some preferred embodiments, this mode would have full support for scrolling as well as for the standard Android user interface (UI) views and layouts. In some preferred embodiments, full-screen application mode 203 may leverage the mobile operating system's native interface rendering technology to flexibly and responsively display dynamic content. Other technologies, such as HTML5 and Flash, may be additionally or alternatively used.

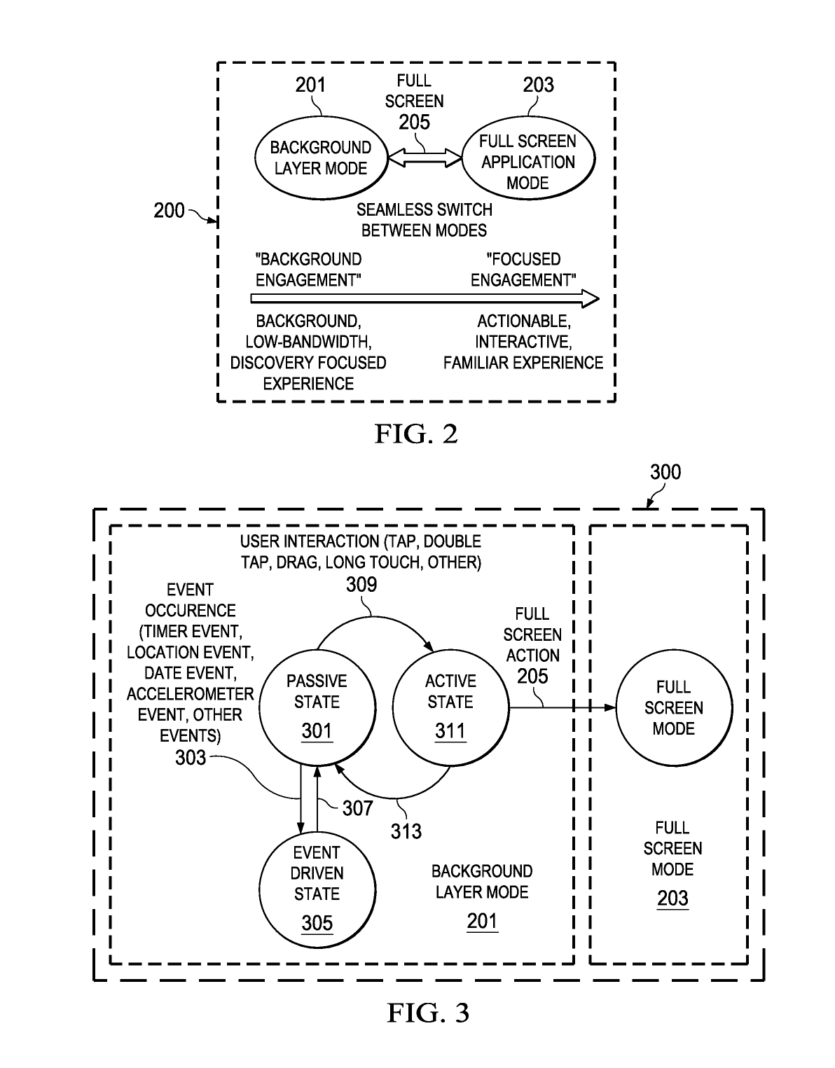

FIG. 3 is schematic diagram of a multi-state architecture 300 that may be used to implement the multi-mode architecture 200 of FIG. 2.

Referring to FIG. 3, the default state of the mobile device may be a passive state 301. During the passive state 301, the screen of the mobile device may be on or off. Certain events may trigger the mobile device to undergo a transition 303 to an event-driven state 305. These events may include timer events, location events, date events, accelerometer events, or other events. When the mobile device is in the event-driven state 305, the mobile device may process the event that triggered the transition 303 before the mobile device returns to the passive state 301 via a transition 307.

When the mobile device is in the passive state 301, certain user interactions may trigger the mobile device to undergo a transition 309 to an active state 311. From the active state 311, the mobile device may undergo an inter-mode transition 205 leaving the mobile device in a full-screen application mode 203. The device may later undergo the inter-mode transition 205 in the opposite direction to return to the background layer mode 201. The specific state (e.g., the passive state 301, the event-driven state 305, or the active state 311) may vary upon returning to background layer mode 201.

In certain scenarios, the mobile device may undergo the transition 309 from the passive state 301 to the active state 311 and then undergo a transition 313 from the active state 311 to the passive state 301 without ever transitioning to the full-screen mode 203.

The following example illustrates practical scenario that may trigger some of the transitions described above. A user may carry a mobile device into the proximity of his or her home, and a location event may occur based on activity captured by the mobile device's GPS, WiFi signal detection, or other means. The location event may trigger the transition 303 leaving the mobile device in the event-driven state 305. When in the event-driven state 305, the mobile device may issue a flag to alert the user about a preferred television show that may be viewable at some time during or after the time at which the location event occurred. The user may not necessarily receive the alert at this time. The mobile device may then undergo transition 307, leaving the mobile device in the passive state 301. At a later time, the user may interact with the mobile device in such a way as to trigger the transition 309, leaving the mobile device in the active state 311. In this active state, the abovementioned flag may be serviced, causing the alert to appear on the screen of the mobile device. After the user observes this alert, he or she may indicate a desire to learn more about the preferred television show by further interacting with the mobile device, causing the inter-mode transition 205 to occur. As a result of this inter-mode transition 205, the mobile device may enter the full-screen mode 203, displaying more content related to the preferred TV show such as viewing times. It may even be possible for the user to watch the TV show directly from the mobile device when the device is in the full-screen mode 203. At some later point, the mobile device may undergo the inter-mode transition 205 back to the background layer mode 201.

In general, the user may take actions on content on the mobile device. In some scenarios, the user may interact with complementary content that is present on proximate devices that are networked with, or connected to, the mobile device.

The robust system of state management may allow the live display layer to consume minimal processing resources and energy. Mobile devices in the system may remain in the passive state 301 of the background layer mode 201 whenever possible to conserve said processing resources and energy. The duration of the event-driven state 305 may be minimized, such that there is just enough time to process a given event. In some embodiments, the event-driven state 305 may be implemented using an interrupt service routine (ISR). The peripherals of the mobile device may also be switched on and off as desired to save additional energy.

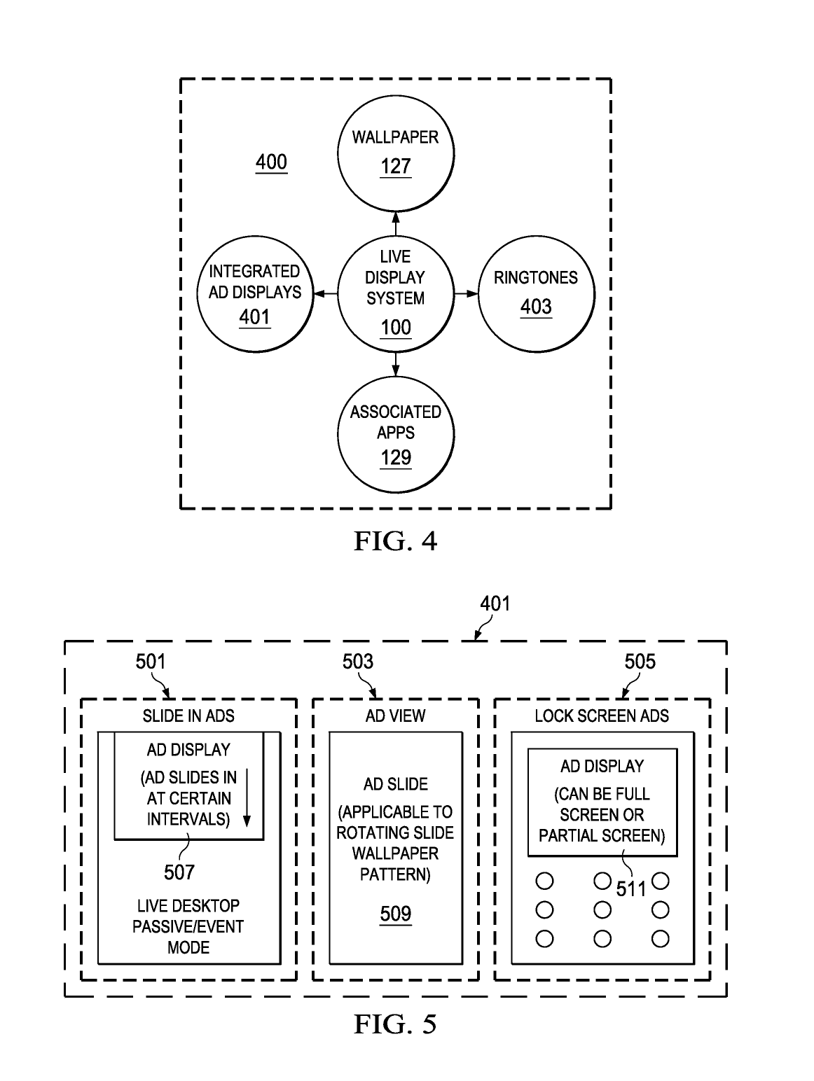

FIG. 4 is a block diagram of a brand engagement ecosystem 400, illustrating some elements of a mobile device with which the live display system 100 may interact. The arrows within FIG. 4 do not necessarily indicate that the elements of the mobile device are external to the live display system 100.

The live display system 100 may have control of a mobile device's background layer or wallpaper 127 as well as the content, format, and functionality of associated applications 129. When the user selects or configures a theme for the live display system 100, the wallpaper(s) 127 and associated application(s) 129 corresponding to that theme may automatically become available on the mobile device. For example, when the user selects a theme that corresponds with a sports team, the mobile device's wallpaper 127 may be updated to provide variable and dynamic content associated with that sports team. Further, the live display system 100 may provide associated applications 129 relating to the sports team, such as a game calendar, a team member compendium, and a video streaming service showing content relating to the selected sports team or sport.

In addition, the live display system 100 may control or set the mobile device's ringtones 403. This functionality may be useful in a variety of scenarios. For example, the user may indicate a preference when listening to music via a music player integrated into the live display system 100. The user may then be presented with the option to set the mobile device's ringtone 403 to reflect the song of interest.

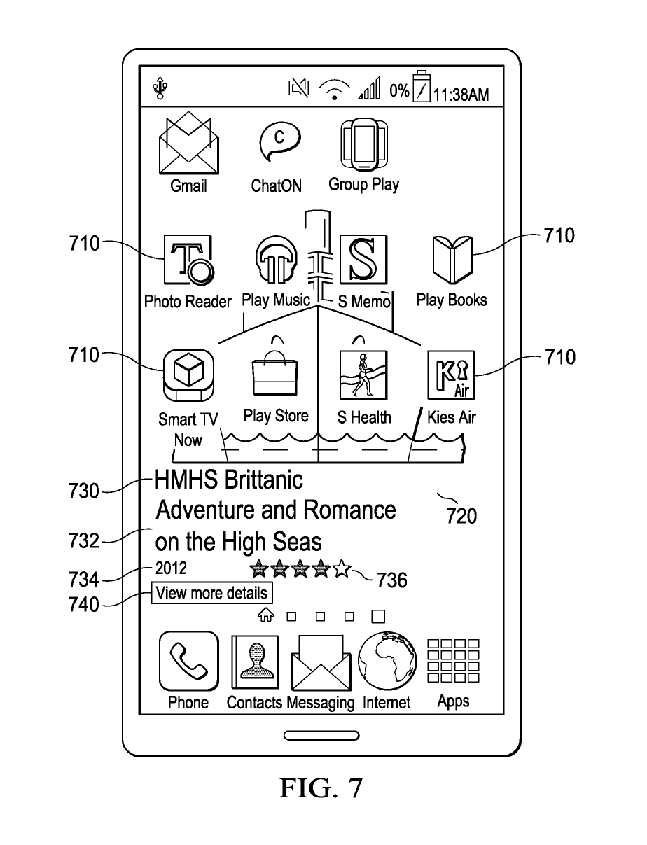

As evidenced above and throughout the present disclosure the live display system 100 provides for a comprehensive solution for brand aggregation. Individual brands (e.g., those pertaining to sporting teams, mobile network operators, or media content providers) may develop and deploy a complete mobile device experience for users by leveraging some or all of the functionality provided by the live display system 100. When combined with the unified development environment (described in further detail in FIG. 6), the brand engagement ecosystem 400 provides a compelling reason for brands to choose the live display system for engaging with users.

The live display system 100 may also include integrated ad displays 401. In general, ad displays 401 may present rich media ads with interactive capabilities or static units driving users towards specific content or offers. The ads' interactive capabilities may include ad-specific interfaces, gesture recognition, and detection of user behavior through other sensors of the mobile device.

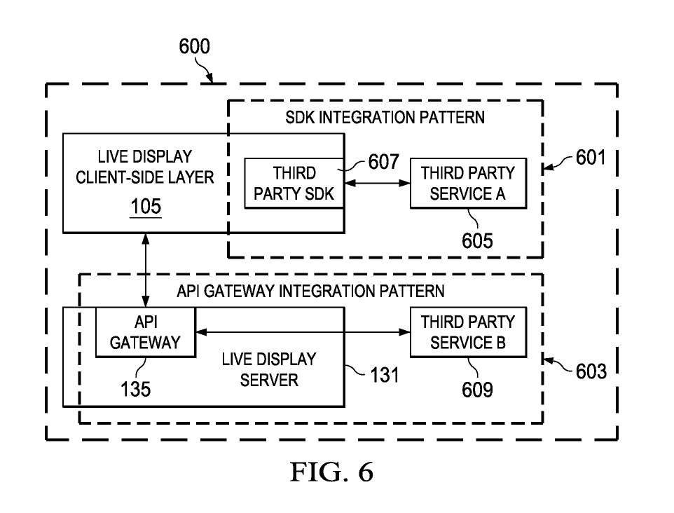

FIG. 5 is a schematic diagram illustrating three implementations of the integrated ad display 401. In some embodiments, the live display system may recognize an opportunity to display a contextualized advertisement through the integrated ad displays 401, based on a variety of factors. The present disclosure illustrates three such integrated ad displays 401, though numerous other implementations exist.

One type of integrated ad display 401 is a slide-in ad display 501, wherein an slide-in ad 507 slides onto the screen when the mobile device is in the background layer mode. The slide-in ad display 501 may be prompted by a transition to an event-driven state or a transition to an active state.

As an exemplary scenario for a slide-in ad display 501, the user may indicate a preference when listening to music through a music player integrated into the live display system. The live display system may use the slide-in ad display 501 to display a slide-in ad 507 for local concert tickets if a related musical artist will be playing nearby the user. As indicated in FIG. 5, the ad 507 may slide onto a portion of the display. The user may then be inclined to select the ad 507, and he or she may perform the selection with a downward swipe of a finger across the screen of the mobile device, for example. This or other actions may cause a transition to full-screen application mode, wherein a full-screen contextualized advertisement appears. In this example, the mobile device may then display availability and opportunity to purchase tickets for the local concert. The user would be able to exit the contextualized advertisement screen in a manner similar to exiting the full-screen application mode.

An ad view display 503 is another example of an integrated ad display 401. The ad view display 503 involves inserting an advertisement into the mobile device's background layer or wallpaper. The ad view display 503 may occur when the user is sliding between different home screens.

Integrated ad displays 401 may also be implemented as lock screen ad displays 505. In the lock screen ad display 505, a lock screen ad 511 appears either fully or partially on the screen of a mobile device during a time when the mobile device is being unlocked by the user.

FIG. 6 is a block diagram of a development ecosystem 600 associated with the live display system in some embodiments. The live display system provides a robust development environment for integration of third party services with the live display system.

To connect third party services to the live display system, the development ecosystem 600 provides two integration patterns: an SDK integration pattern 601 and an API gateway integration pattern 603. Depending on the functionality of the third party service, one integration pattern may be better suited than the other. Of course, other integration patterns may be appropriate depending on the developers' intended goals and degree of integration.

In the SDK integration pattern 601, the live display client-side layer 105 residing on mobile devices may be developed or modified using a third party SDK 607 associated with a third party service 605. For example, the SDK integration pattern 601 may be used when integrating the live display system with ad networks or analytics services. The modifications may be made to the live display client-side layer 105 itself.

In other cases, the API gateway integration pattern 603 may be more suitable. In this integration pattern, the API gateway 135 provides access to the live display server 131. Developers may use the API gateway 135 to connect certain third party services 609 to the live display system. The API gateway integration pattern 603 may be ideal for developing applications to be used in the live display system or for providing dynamic content to mobile devices through the live display server 131.

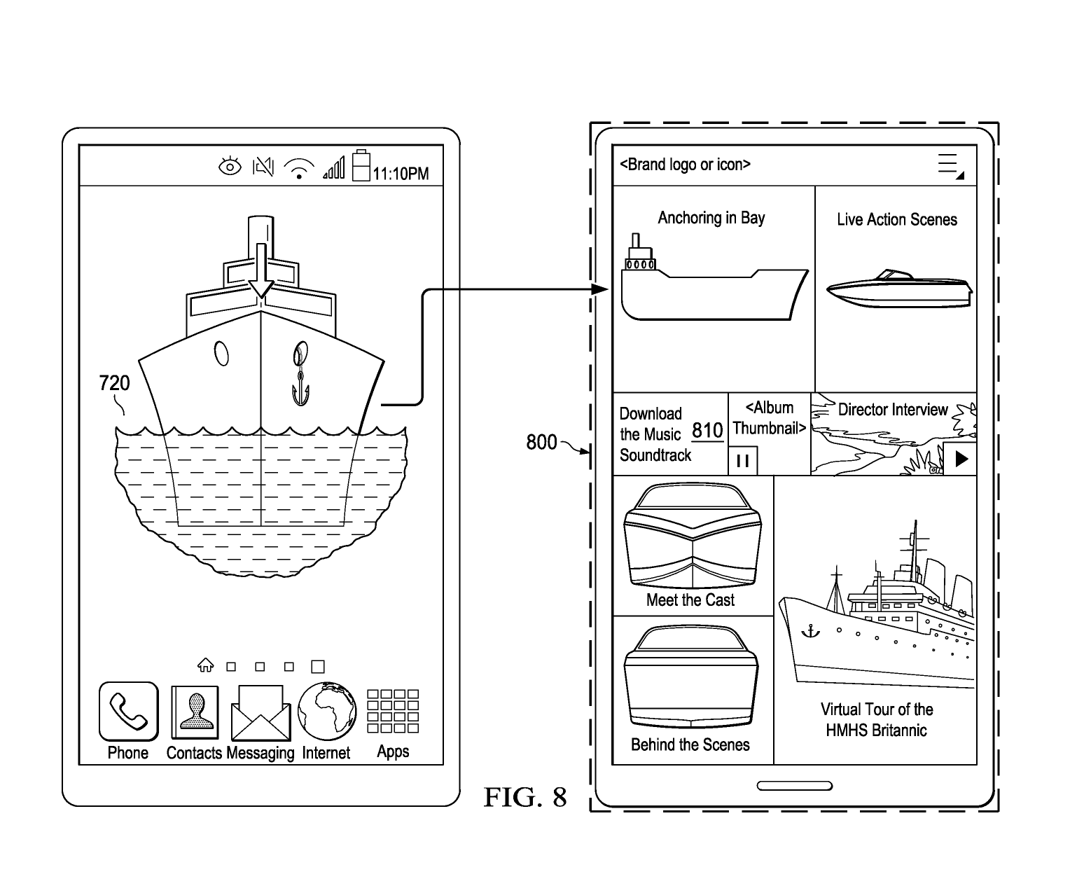

FIG. 7 shows a schematic diagram illustrating the mobile device's home screen when in a background layer mode. The figure demonstrates that the background content can be promoted without interfering with the foreground content. For example, foreground application icons 710 may be overlaid on top of a background layer 720 provided by a theme or live wallpaper.

In this example, the live display client-side layer has a background layer 720 associated with a video streaming service. While this embodiment focuses on a video streaming service, and the teachings described herein could be applied to other themes and embodiments of the present disclosure.

The background layer 720 may show a “hero” image that is a prominent part of the background. In this example, the hero image may pertain to video content (e.g., a movie) that is available for streaming from the video streaming service. The background layer 720 may provide a title 730, a subtitle 732, release data 734, a content rating 736, and a “call to action” button 740. The user may interact with the background layer 720 through a variety of actions such as swiping a finger across the screen of the mobile device or selecting a portion of the background layer 720 such as the “call to action” button 740. Other portions of the background layer 720 may also be selectable, such as a brand logo or a more subtle feature within an image. In some embodiments, multi-touch gestures may be used. The specific content shown in the background layer 720 may vary over time and may be different upon the user opening the home screen. For example, the background layer 720 may be updated to feature content currently being watched (or recently watched) by a friend of the user. The content also may be chosen based on information collected on the user or the user's explicitly indicated preferences (e.g., during configuration of the live wallpaper associated with the background layer 720).

In some embodiments the background layer 720 may pertain to an advertisement that may be relevant to a user's interests. Other non-limiting examples of background layers include those pertaining to home integration services, personal fitness services, mobile network operators, and/or music content providers.

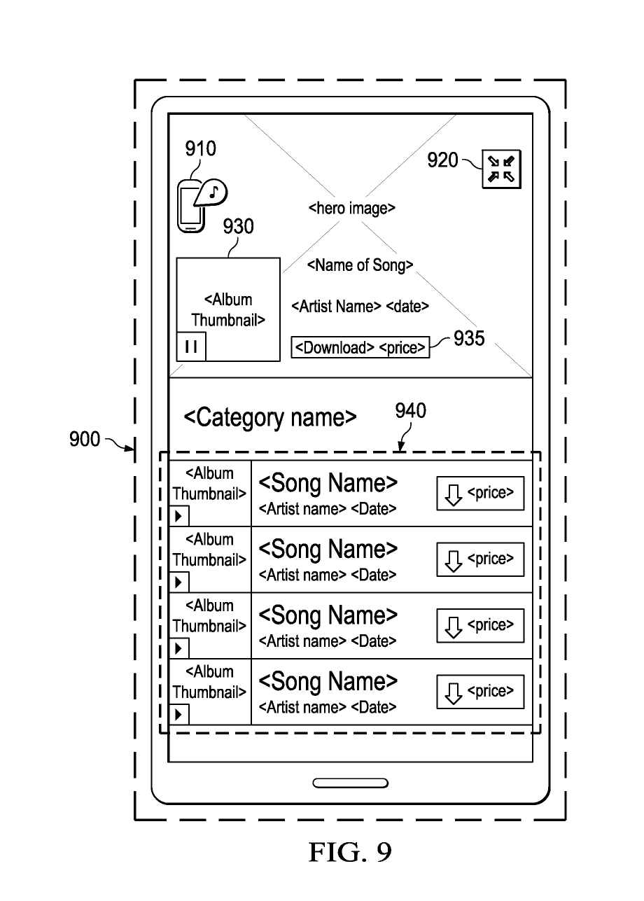

FIG. 8 shows a schematic diagram illustrating how the mobile device may enter a full-screen application mode. The user may downwardly swipe a finger across the screen to initiate full-screen application mode with an application 800 associated with the background layer 720. Other gestures for transitions are possible, including swiping a finger away the from the corner of the screen as if to peel a label or tapping on a logo or other element integrated into the background layer 720. The associated application 800 may open with content that is relevant to the previously displayed content of the background layer 720. The associated application 800 may also be customized to match the user's preferences, such that the presented content is tailored to the user.

The associated application 800 may present content in a variety of ways as established by application metadata. In this embodiment, the content is arranged in tile format when the application first opens. This arrangement provides a compact interface that may present the user with multiple different types of content. The content may be hosted on a live display server (or cached locally) and may be rendered on the device using rendering capabilities native to the mobile operating system and/or other rendering technologies such as HTML5. The content may also be intertwined with application functionality such as the option to download a song shown in the tile 810.

The application content may be highly dynamic as it may be synchronized with or requested from the live display server. In some embodiments, the application content may be requested upon opening the application 800. In some embodiments, the application content may be periodically or otherwise automatically pulled from the live display server and stored within local cache to promote a more responsive user interface.

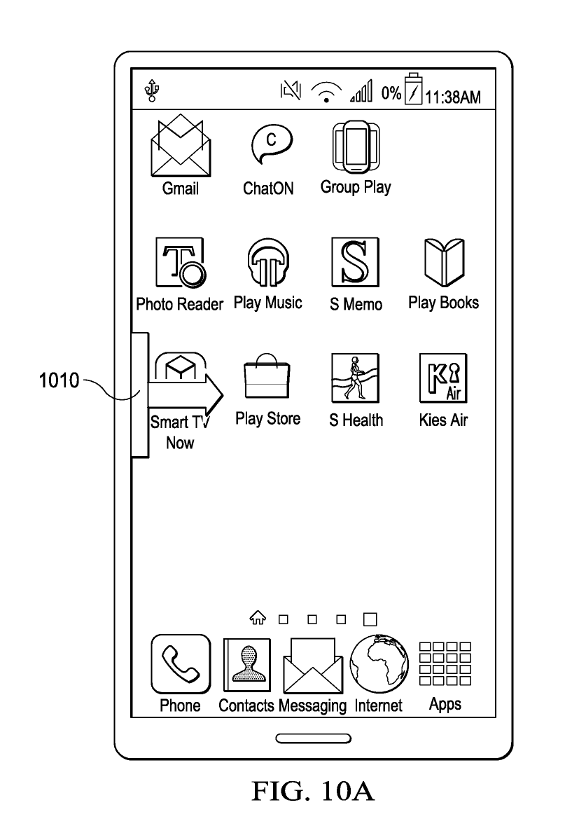

FIG. 9 shows a schematic diagram illustrating another example of dynamic application content and functionality within an application 900. In this embodiment, the application 900 may present a button 910 which may trigger the launch of a related application. Another button 920 may change the layout of the application by minimizing a portion of the application.

When the application 900 loads onto a mobile device, certain associated content can be loaded simultaneously with the application 900 or upon user request. In this example, an MP3 file may be loaded and stored locally, such that the mobile device could play the song contained within the MP3 file without leaving the application 900. The MP3 file may be associated with the icon 930 near the top left corner. The MP3 file may be played and paused by the user tapping the icon 930. Other content may be available from outside of the application 900 and a uniform resource indicator (URI) may be used to point to the resource. In this case, if the user desires to purchase the song, he or she may tap on the “download” button 935 to the right of the icon 930. If this occurs, the mobile device may temporarily exit or minimize the application 900 and present content from within an integrated content store. However, the state of the application 900 may be stored, such the that the user may return to where he or she left off. For example, if the user presses a “back” button implemented through either hardware or software when in the integrated content store, he or she may return to the application 900.

The application may also include a dynamic frame 940 that provides a convenient way to vary songs and provide new content (e.g., based on external content feeds). The application may provide contextual features (e.g., links to purchase content) for the content within the dynamic frame 940, and the mobile device may locally store samples associated with the content within the dynamic frame 940.

As evidenced in this example, contextual functionality (e.g., for facilitating the purchase of a song) may be provided within applications, and the contextual functionality may be closely integrated with the content within the applications. The layout of the content and the contextual functionality may be determined, at least in part, by metadata associated with a dynamic application package and/or received from the live display server (e.g., mapped from external services or provided by the content management server). In general, application layouts such as those shown in FIGS. 8-9 may be created “on-the-fly” within fully configurable application containers on the mobile device. For example, the application of FIG. 8 may transform into the application of FIG. 9 transparently to the user.

FIGS. 10A-10B show schematic diagrams illustrating a sample home screen of a mobile device having a tray. In FIG. 10A, the tray 1010 is collapsed but visible at the edge of the screen. The user may swipe a finger horizontally across the screen to expand the tray 1010 as shown in FIG. 10B. In some embodiments, other gestures, such as multi-touch gestures may be used to expand the tray 1010. The expanded tray 1010 may provide additional content or contextual features that may relate to the current live wallpaper. The tray 1010 may be rendered using the same application framework used for the full-screen applications and/or for the background layers.

The content and functionality contained within the expanded tray 1010 may vary to align with the background layer and/or the full screen applications. For example, the tray 1010 may provide links to associated applications that are aware of the content being presently displayed within the background layer. Certain portions of the background layer may be directly associated with content within the tray 1010. For example, a primary content element within the tray 1010 (e.g., the first or left most content element) may be associated with a primary content element of the background layer (e.g., a visually emphasized feature or location). The tray 1010 may be dynamically updated to provide functionality such as an integrated music or video player that may relate to the content in the background layer. The content and functionality within the tray 1010 may be periodically or semi-periodically pre-cached locally on the mobile device. In some embodiments, the local cache also may be updated when the tray 1010 is opened.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It should be understood that various embodiments of the present disclosure can employ or be embodied in hardware, software, microcoded firmware, or any combination thereof. When an embodiment is embodied, at least in part, in software, the software may be stored in a non-volatile, machine-readable medium.

A machine-readable medium may comprise any collection and arrangement of volatile and/or non-volatile memory components suitable for storing data. For example, machine-readable media may comprise random access memory (RAM) devices, read only memory (ROM) devices, magnetic storage devices, optical storage devices, and/or any other suitable data storage devices. Machine-readable media may represent any number of memory components within, local to, and/or accessible by a processor.

As referred to herein, a machine may be a virtual machine, computer, node, instance, host, or machine in a networked computing environment. Also as referred to herein, a live display system may comprise collection of machines connected by communication channels that facilitate communications between machines and allow for machines to share resources. A network may also refer to a communication medium between processes on the same machine. Also as referred to herein, a server is a machine deployed to execute a program operating as a socket listener and may include software instances. Such a machine or engine may represent and/or include any form of processing component, including general purpose computers, dedicated microprocessors, or other processing devices capable of processing electronic information. Examples of a processor include digital signal processors (DSPs), application-specific integrated circuits (ASICs), field-programmable gate arrays (FPGAs), and any other suitable specific or general purpose processors.

Servers may encompass any types of resources for providing data including hardware (such as servers, clients, mainframe computers, networks, network storage, data sources, memory, central processing unit time, scientific instruments, and other computing devices), as well as software, software licenses, available network services, and other non-hardware resources, or a combination thereof.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “immediately,” “equivalent,” “during,” “complete,” “identical,” and the like should be understood to mean “substantially at the time,” “substantially immediately,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for providing interactive and dynamic content on a device, the method comprising:
receiving, via a communication interface of the device, a dynamic application package;
providing, by a background layer engine of the device, a background layer comprising background content, the background layer being dependent, at least in part, upon the dynamic application package,
wherein the background layer is presented on the device when the device is in a first mode; and
providing, by a metadata-driven application engine, a dynamic application comprising application content, the dynamic application being dependent, at least in part, upon the dynamic application package,
wherein the dynamic application is presented on the device when the device is in a second mode.

2. The method of claim 1, wherein the application content of the dynamic application relates to the background content of the background layer

3. The method of claim 1, further comprising:
receiving, via the communication interface, metadata from a server after the communication interface receives the dynamic application package, the metadata providing at least one of a layout and contextual functionality for the dynamic application when the device is in the second mode.

4. The method of claim 1, further comprising:
receiving, by the communication interface of the device, additional content from a server after the communication interface receives the dynamic application package.

5. The method of claim 4,
wherein the dynamic application comprises a content frame; and
wherein the additional content is presented in the content frame of the dynamic application when the device is in the second mode.

6. The method of claim 4, further comprising:
providing, by the metadata-driven application engine, contextual functionality associated with the additional content when the device is in the second mode, the contextual functionality based, at least in part, upon metadata received with the additional content from the server.

7. The method of claim 6, wherein the metadata is represented in JavaScript Object Notation (JSON).

8. The method of claim 6, wherein the additional content comprises media content, and wherein the contextual functionality comprises controlling playback of the media content.

9. The method of claim 4, wherein the additional content is pushed to the device on a periodic basis.

10. The method of claim 4, wherein the additional content is pushed to the device during a time corresponding to at least one event selected from the group comprising an album release, a movie premiere, and a sporting event.

11. The method of claim 4, further comprising:
caching, by a local cache in communication with the metadata-driven application engine, the additional content received from the server.

12. The method of claim 1, further comprising:
rendering, by the metadata-driven application engine, the dynamic application using HTML5 when the device is in the second mode.

13. The method of claim 1, further comprising:
receiving a user input during a time when a user interacts with the device; and
transitioning from the first mode to the second mode based, at least in part, upon the received user input.

14. A device operable to provide interactive and dynamic content, the device comprising:
a communication interface operable to receive a dynamic application package;
a background layer engine operable to provide a background layer comprising background content, the background layer being dependent, at least in part, upon the dynamic application package,
wherein the device is operable to present the background layer when the device is in a first mode; and
a metadata-driven application engine operable to provide a dynamic application comprising application content, the dynamic application being dependent, at least in part, upon the dynamic application package,
wherein the device is further operable to present the dynamic application when the device is in a second mode.

15. The device of claim 14, wherein the application content of the dynamic application relates to the background content of the background layer

16. The device of claim 14, wherein the communication interface is further operable to receive metadata from a server after receiving the dynamic application package, the metadata providing at least one of a layout and contextual functionality for the dynamic application when the device is in the second mode.

17. The device of claim 14, wherein the communication interface is further operable to receive additional content from a server after receiving the dynamic application package.

18. The device of claim 17,
wherein the dynamic application comprises a content frame; and
wherein the device is further operable to present the additional content in the content frame of the dynamic application when the device is in the second mode.

19. The device of claim 17, wherein the metadata-driven application engine is further operable to provide contextual functionality associated with the additional content when the device is in the second mode, the contextual functionality based, at least in part, upon metadata received with the additional content from the server.

20. The device of claim 17, further comprising:
a local cache in communication with the metadata-driven application engine, the local cache operable to cache the additional content received from the server.
